(19) United States
(12) Patent Application Publication
(10) Pub. No.: US 2014/0108112 A1
(43) Pub. Date: Apr. 17, 2014

(54) ONLINE DISTRIBUTION AND ACCUMULATION OF INCENTIVE REWARDS

(71) Applicant: Harry Truong Mokm, Seattle, WA (US)

(72) Inventor: Harry Truong Mokm, Seattle, WA (US)

(21) Appl. No.: 13/650,923

(22) Filed: Oct. 12, 2012

(51) Int. Cl. G06Q 30/02

(52) U.S. Cl. 705/14.16; 705/14.27

(57) ABSTRACT

A business system and method for providing online distribution and accumulation of incentive rewards according to the present invention comprises one or more rewards accumulation accounts which can be designated to the buyer himself or herself or any beneficiary. The system and method allows the buyer to save and accumulate the earned rewards and accumulate interest for a set of specific objectives, for example, retirement or education. The rewards in the accumulation account can be redeemed and cashed out only when the set objectives or conditions are met. This business system and method helps people to save money from normal daily living necessity spending.

### BACKGROUND OF THE INVENTION

1. Field of the Invention

This invention relates generally to reward programs, and particularly to an online distribution and accumulation of incentive rewards.

2. Description of Related Art

Merchants always compete with each other through products' quality, customer service and advertisement in order to attract customers and keep their long term loyalty. Many merchants also provide monetary/price reduction/coupons to reward customers' loyalty so that the customers can do repeated business with them. The rewards offered by the merchants may be in the form of a cash rebate. No matter whether the cash rebate is offered in a form of a credit/debit card or other means, it normally has an expiration date so that the customers have to spend the money before the cash rebate offer is expired. Most customers have tendency to purchase something not necessary but can satisfy their desire because they feel the earned rewards are extra money for them to spend.

Currently, there is no reward program that allows customers to save and accumulate rewards and interest for future use.

Therefore, there is a need to have a reward program that encourages long-term saving for a set of specific objectives, for example, customer's retirement or children's education instead of immediately spending on something not necessary.

### SUMMARY OF THE INVENTION

It is an object of the present invention to provide a business method and system that can encourage a buyer to save earned rewards for future necessary spending such as retirement or education. The “buyer” is also referred to as a “customer”, “consumer” or “demand side”.

It is another object of the present invention to provide a business method and system that can help a merchant to promote sales and customers' loyalty at the same time. The “merchant” is also referred to as a “manufacturer”, “retailer”, “supplier”, “supply side”, or any entity that supplies or sells products or services including a restaurant, financial institution, etc.

In an exemplary embodiment of the present invention, there is disclosed a business method and system for providing online distribution and accumulation of incentive rewards comprising one or more Reward Accumulation account(s) which can be created for the customers to save and store earned rewards for long term goals. The reward accumulators may be designated to the customer himself/herself or any beneficiaries by the customer. The system and method of the present invention allows customers to save and accumulate the earned rewards for a set of specific objectives, for example, retirement or education, etc. The rewards in the accumulator can be redeemed and cashed out only when a set of conditions are met. This business system and method helps people to save money from normal daily living necessity spending.

The business method and system of online distribution and accumulation of incentive rewards is a business model which comprises a computer software permitting manufacturer/retailers (i.e. supply side) to list or post their products with rewards offered as incentives to attract consumers to buy their products. These offered Rewards have different levels of attributes and conditions that can be viewed and selected by customers. These rewards associated attributes and conditions can influence a consumer's decision-making for purchasing a product. Once the customer makes a purchase, the rewards can then be automatically channeled and organized into a Reward Accumulation account that has been created for the customer for a future specific objective use. The buyer member can withdraw or redeem these rewards when set objectives/conditions are met, for example, when a child reaches college education or when one reaches retirement age.

Moreover, the business method and system according to the present invention is unique in that a customer can create a “Derivation of Rewards”, which includes options that would affect the final Reward. Consequently, this derivation of rewards would in turn affect a buyer's decision to make his/her purchase. These “reward derivative” could be set with added value which is changed with time/motive, physical or psychological factors.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a block diagram representing a business system and method for providing online distribution and accumulation of incentive rewards according to embodiments of the present invention.

FIG. 2 is a block diagram of a merchants' membership processor.

FIG. 3 is a perspective view of the merchants' products offered rewards processor.

FIG. 4 is a perspective view of the merchants' products and rewards database.

FIG. 5 is a screen shot of the merchant's profile illustrating product and different levels of product reward attributes.

FIG. 6 is a buyer rewards flow chart.

FIG. 7 is a screen shot of a buyer's reward accumulation account.

FIG. 8 is a perspective view of a database holding all buyers' reward accumulation account information.

### DESCRIPTION OF THE PREFERRED EMBODIMENT

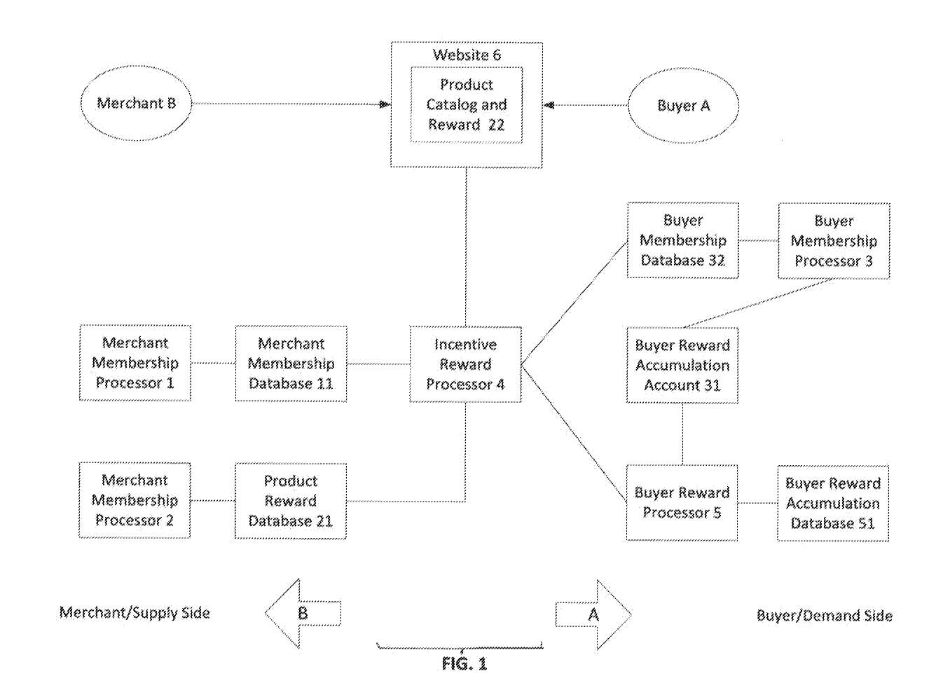

Referring to FIG. 1 there is disclosed a block diagram of a business method and system 100 for providing online distribution and accumulation of incentive rewards according to the present invention. This business method and system 100 comprises a merchant membership processor 1 for creating/maintaining a merchant account and membership database 11; merchant products offered reward processor 2 for creating/maintaining a product reward database 21; buyer membership processor 3 for creating one or more reward accumulation accounts 31 for the buyer and a buyer database 32; incentive reward process 4 for retrieving product reward information from the product reward database 21 and channeling into the reward accumulation accounts 31; buyer's reward accumulation processor 5 for creating and maintaining the reward accumulation accounts database 51, and a website 6 for the merchant to create profile and product catalog and for the buyer to search for the products and log into his/her account 31.

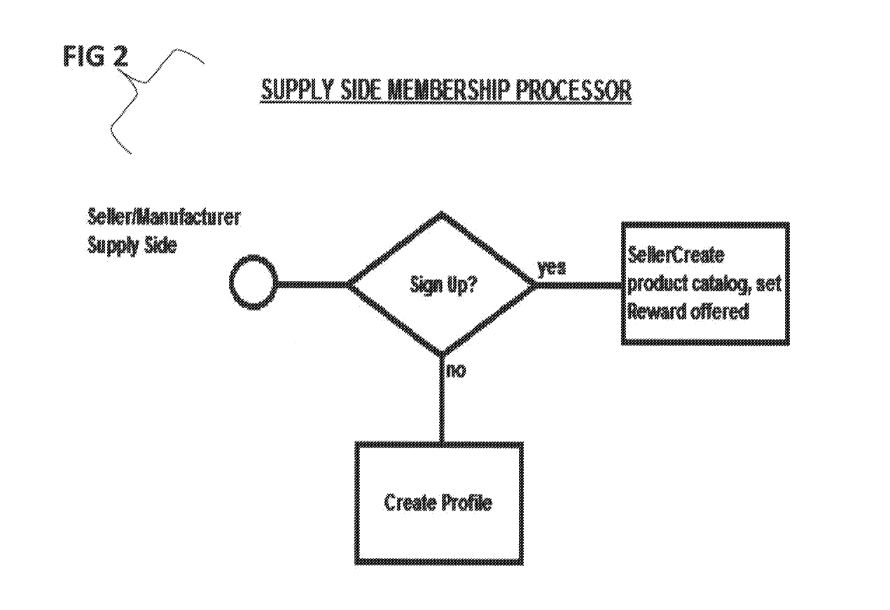

As shown in FIGS. 1 and 2, any merchant who meets the necessary requirements/ standards can enroll into the reward system 100 of the present invention. Upon the merchant's request, the merchant membership processor 1 will create a merchant account for the enrolled merchant and allow the enrolled merchant to create a profile over the network. The processor 1 generates and maintains merchant membership database 11. Once a merchant enrolls into the reward system 100, the merchant can create an online product catalog and set reward offered 22 with the listing products as illustrated in FIGS. 1 and 2.

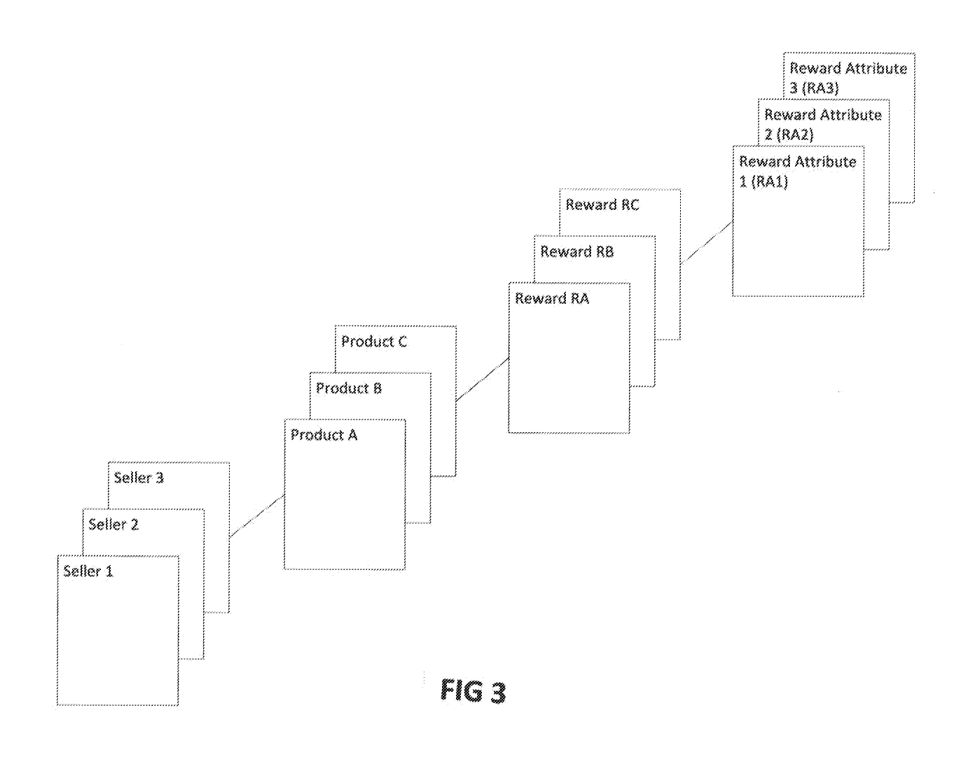

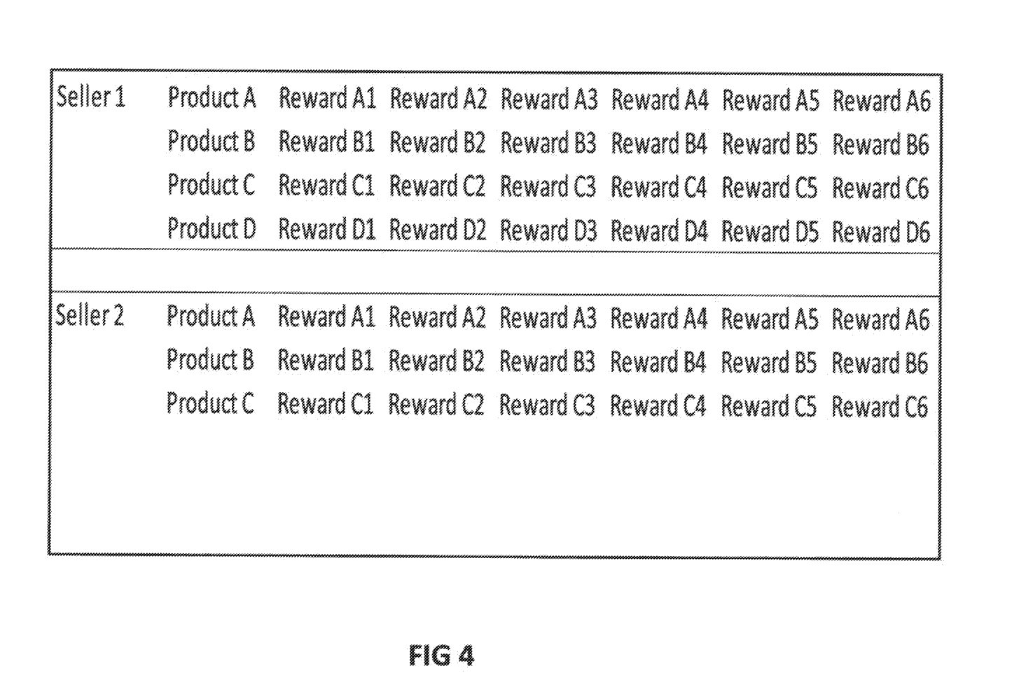

The product offered reward processor 2 enables the merchant to create an online product catalog and rewards 22, and create a set of attributes and conditions associated with the listing products and rewards as shown in FIG. 3 and FIG. 4. The product offered reward processor 2 updates and maintains the merchant's products and rewards database 21 and display online product catalog 22 and rewards with attributes and conditions on the website (either the merchant's website or the system's central website) for customers to access/view.

As shown in FIG. 4, single or multiple rewards can be assigned to each product. Single or multiple reward value can be assigned to each product. The reward value can be in the form of cash rebate or price reduction or coupon. The reward attributes may be a statement, a promise, an action, a condition set by the merchant, or other physical or psychological factors. Depending on different reward attributes, the value of the “product offered reward” may be different. Thus, when the buyer makes a purchase, he/she will receive different rewards based on the decision made.

For example,

A toy seller offers to sell toy A with 2 Rewards.
First Reward A1=$5 if a buyer would write an honest comment about product Toy A.
Second Reward A2=$10 if a buyer tells “I love my Toy A” to everyone that he/she knows.

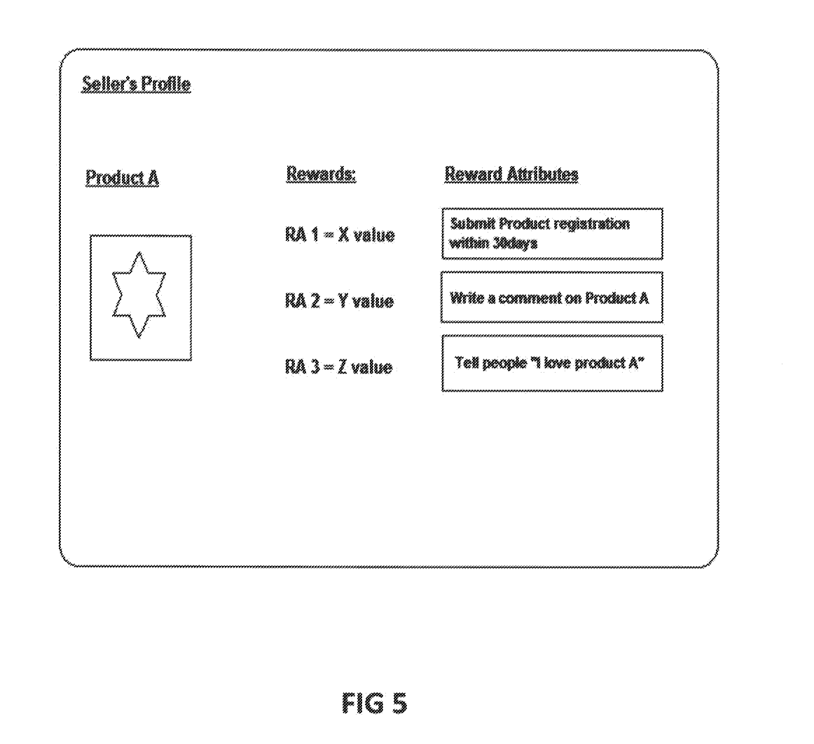

A screen shot of a reward attributes is presented in FIG. 5 to give an additional explanation. FIG. 5 is a screen shot of a seller's profile which shows that for product A, there are three reward values assigned to the product A. First reward A1=X value if a buyer submit product registration within 30 days. The second reward A2=Y value if a user submits a comment about the product A. The third reward A3=Z value if a user tells everyone “I love product A”.

Any consumer who meets specified criteria can take advantage of the online distribution and accumulation of incentive rewards program offered by the business method and system 100 according to the present invention. A customer can choose to join the buyer membership before or after making a purchase from the participating merchants. Once a customer signs up for the membership and accepts the governed rules and regulations, the buyer membership processor 3 will create a member profile for the customer. At the same time, one or more reward accumulation account(s) 31 (like a piggy bank) can be created for the same customer to save or store the earned rewards. One customer can hold one or multiple reward accumulation account(s) which can be designated to one or multiple persons. The customer can designate the reward accumulation account to himself/herself or to a third party beneficiary. The buyer membership processor 3 creates and maintains buyer membership database 32.

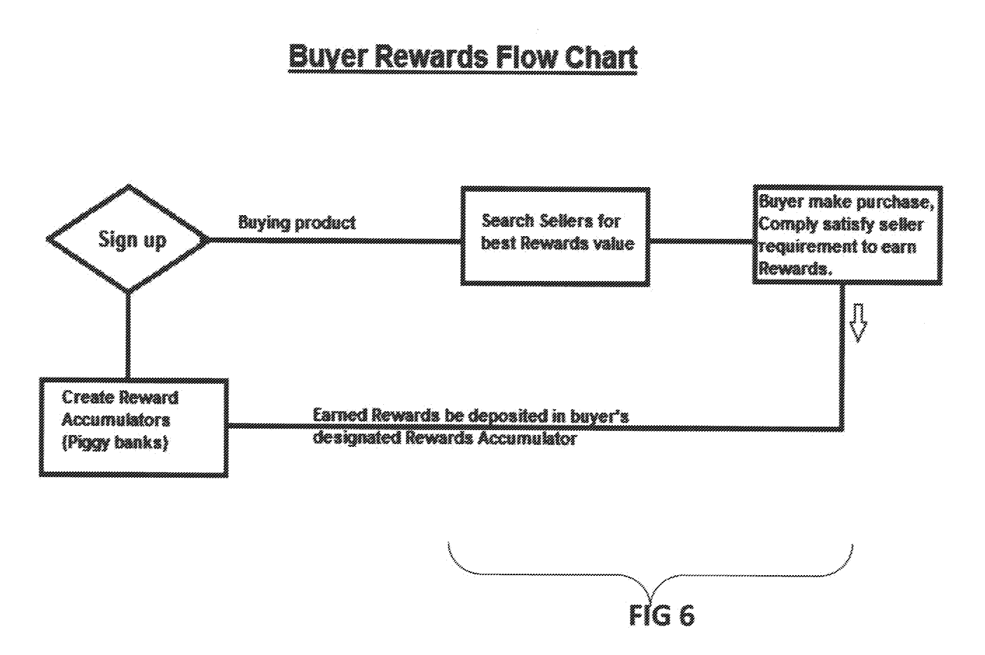

FIG. 6 shows a buyer rewards flow chart. Once a user signs up to become a member, he/she can search sellers for best reward values. When the buyer makes a purchase, the products offered reward processor 2 will grant the buyer with the earned rewards according to the rewards terms and attributes. Then, the reward information is processed and submitted to the incentive reward processor 4 which will coordinate, organize, and channel the earned rewards into the buyer's designated reward accumulation account 31.

If the user has no reward accumulator yet, the buyer membership processor 3 will create one or more reward accumulation account(s) for the buyer so that the rewards can be deposited in the reward accumulation account 31. This reward accumulation account 31 is created and held on conditions with specific long-term objectives, such as individual's retirement or children's education, etc.

To encourage buyers to save the rewards for long term, the rewards in the reward accumulation account 31 may be given financial benefits such as a generous interest rate or tax deferred interests. The rewards in the reward accumulation account 31 may be withdrawn or cashed out when one of the set objectives is met. Early withdrawal from the reward accumulation account may incur penalty in order to encourage customers to save for life's long-term milestones. This is also beneficial to the participating merchants because the merchants do not have to pay off the rewards at once. Instead, the merchant can invest the fund to generate more fortune.

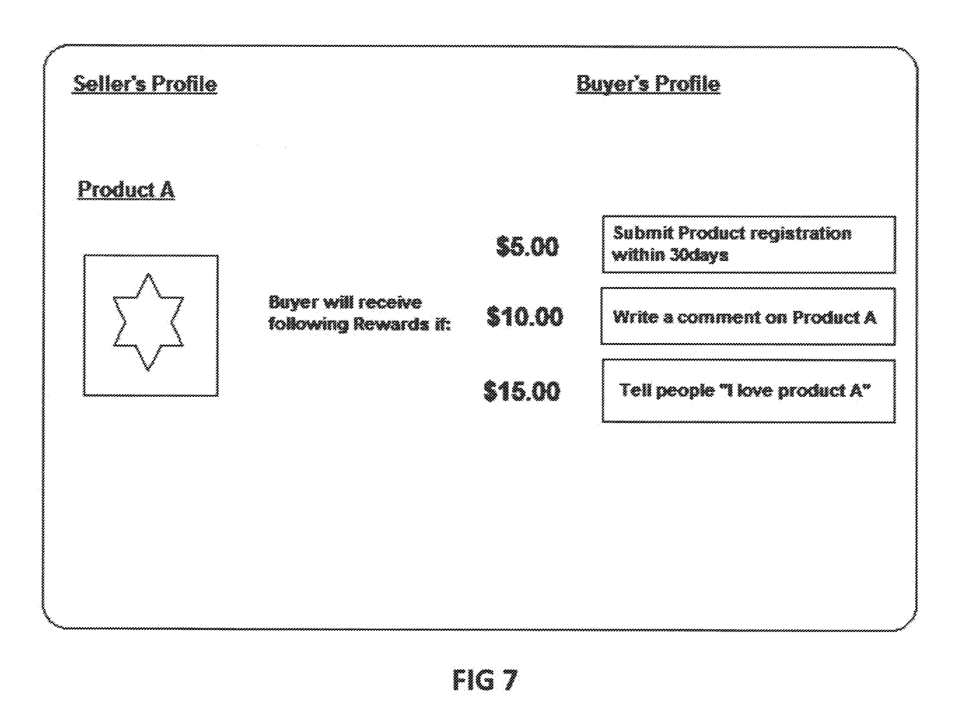

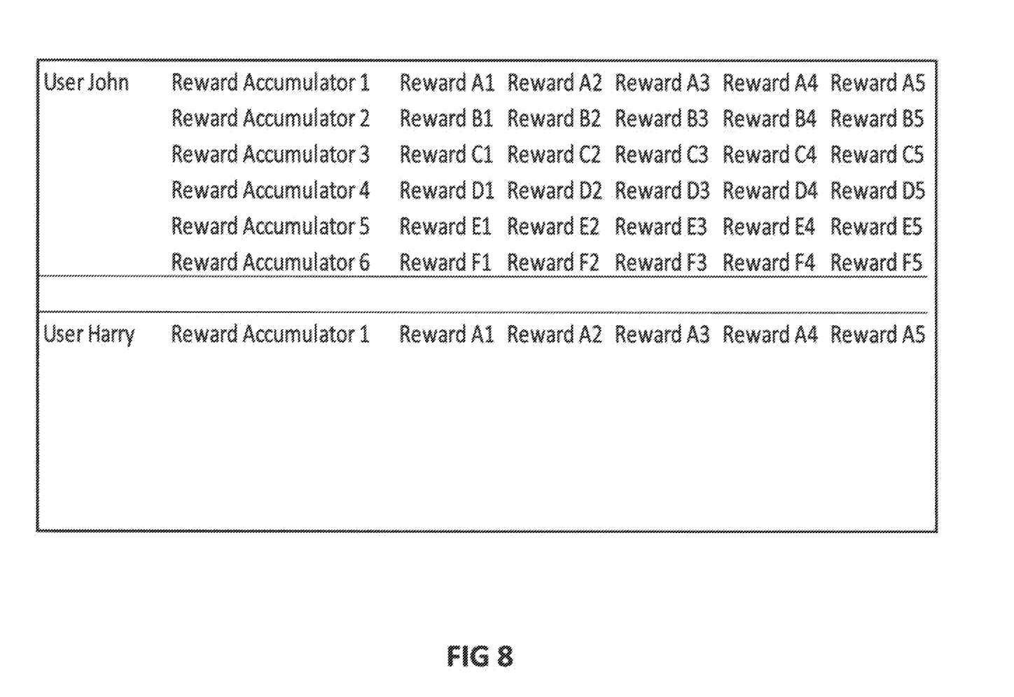

The reward accumulation processor 5 receives the earned rewards from the incentive reward processor 4 and adds on top of the rewards already in the reward accumulation account 31. The reward accumulation processor 5 updates the reward accumulation account 31 and displays it on website 6 upon the request of the buyer. Buyer can see his/her own profile and reward accumulation accounts on the merchant's website or the system's website. FIG. 7 is an exemplary screen shot of one reward accumulation account 31 wherein the buyer receives five dollars for submitting product registration within 30 days, 10 dollars for writing a comment on product A and 15 dollars for telling people “I love product A”. As shown in FIG. 8, the reward accumulation processor 5 maintains the database 51 of the rewards in each accumulation account 31 of all buyer members.

Additionally, a buyer can earn “rewards” to be stored in the reward accumulation accounts and accumulate interests by promising to buy a certain product in the future, or telling a friend to buy a certain product, etc. For example, a buyer promises today that he/she will buy product “A” by Dec. 31, 2015, and immediately earn $5. This $5 will be credited to the buyer's reward accumulation account at once and start to accumulate interest at once but the customer will only receive the reward ($5 and interest) when he/she actually makes the purchase.

In another embodiment, a customer can create a “Derivation of Rewards”, which includes options that would affect the final Reward. Consequently, this derivation of rewards would in turn affect buyers' decision to make his/her purchase. These “reward derivative” could be set with added value which is changed with time/motive, physical or psychological factors.

In another embodiment, the products offered reward processor, incentive reward processor, and reward accumulation processor can be integrated as one.

In one embodiment, the business system and method 100 of the present invention has a website for the buyers to visit online and view their profile and reward accumulation accounts. The website also displays the participating merchants' profiles, product catalogs, and products offered rewards for the buyers to view and make purchase.

In another embodiment, the participating merchants display their product catalog and products offered rewards on their own websites and have a link to redirect the buyer to the system's website to view their reward accumulation account upon the buyer making a purchase.

In another embodiment, the participating merchants may buy a license of this reward accumulation system and method including software so that they can incorporate the reward accumulation system and method into their own system and manage the accumulation account in their own database and website for their own customers.

The business method and system 100 for providing online distribution and accumulation of incentive rewards of the present invention is not limited to the manufacturers or retailers. The system and method 100 can also be utilized by financial institute who issues credit cards and debit cards. Whenever buyers use their credit cards/debit cards to purchase stuff, they may get 1% or 5% cash back. These cash back can also be saved in the reward accumulation account to save for a set of long-term objectives.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

1. An online network electronic system for providing online distribution and accumulation of incentive rewards, said system comprising:
a plurality of computer processors, wherein said computer processors further comprising:
a merchant membership processor for creating member accounts for merchants and maintaining a merchant member account database;
a merchant offered-reward processor which processes a reward to a customer from a merchant member and maintains a merchant reward database wherein said reward is awarded to the customer of the merchant for fulfilling a required customer activity, and said merchant reward database being linked with said merchant member account database;
a user membership processor for creating a user member account, and maintaining a user member account database, wherein said user member account includes a long term goal-setting account for accumulating rewards;
a management processor for coordinating and channeling interactions between a merchant account, a user account and/or a system agent.

2. The online network electronic system of claim 1, wherein said long term goal-setting account has a goal conditioned for being used for college education of a person designated by the user.

3. The online network electronic system of claim 2, wherein said long term goal-setting account can be withdrawn or redeemed only when set conditions are met, early withdrawal renders a penalty.

4. The online network electronic system of claim 2, wherein a user can have multiple long term goal-setting accounts and each long term goal-setting account being designated a different beneficiary.

5. The online network electronic system of claim 1, wherein the system allows a user to create a derivation of rewards which includes options, with added value which is changed with time/motive, physical or psychological factors.

6. The online network electronic system of claim 1 further comprising a module allowing a user to earn reward by promising to purchase or telling friends to purchase a certain product in the future.

7. The online network electronic system of claim 1, wherein said customer activity is about providing an online feedback review of a purchase.

8. The online network electronic system of claim 1 wherein said long term goal-setting account has a goal conditioned for being used for contribution to a retirement account of a person designated by the user.

9. The online network electronic system of claim 1, wherein said reward includes an hierarchy of structure soliciting a plurality of activities from a customer.

10. The online network electronic system of claim 1 wherein said customer activity is about submitting an online registration.

11-19. (canceled)
